(19) United States
(12) Patent Application Publication
(10) Pub. No.: US 2014/0175223 A1
(43) Pub. Date: Jun. 26, 2014

(54) AIRCRAFT FRONT PORTION HAVING AN IMPROVED LANDING GEAR BAY

(71) Applicant: Airbus Operations (SAS), Toulouse (FR)

(72) Inventors: Yves Durand, Aussonne (FR); Bernard Guering, Montrabe (FR)

(21) Appl. No.: 14/138,581

(22) Filed: Dec. 23, 2013

(30) Foreign Application Priority Data
Dec. 21, 2012 (FR) 1262583

(51) Int. Cl. B64C 25/00; B64D 11/00; B64C 1/18

(52) U.S. Cl. CPC B64C 25/001; B64C 1/18; B64D 11/00
USPC 244/119

(57) ABSTRACT

An aircraft front portion in which the landing gear storage bay is arranged under a cockpit floor. The landing gear bay is mechanically connected to the fuselage frames of the aircraft front portion in order to perform the function of taking up the mechanical forces acting on the fuselage frames under the effect of pressurization. The cockpit floor is thus simplified since it serves solely as a plane for the crew to walk on and it can be lowered so as to release space in the cockpit.

### CROSS-REFERENCES TO RELATED APPLICATIONS

This application claims the benefit of the French patent application No. 1262583 filed on Dec. 21, 2012, the entire disclosures of which are incorporated herein by way of reference.

### BACKGROUND OF THE INVENTION

The invention relates to an aircraft front portion and to the arrangement of a nose landing gear storage bay therein.

In certain aircraft, the nose landing gear storage bay is arranged in a bottom zone situated at the front of the aircraft, under the floor of the deck of the cabin zone dedicated to passengers and a front zone dedicated to the cockpit.

In particular in the empty space around the nose landing gear bay, the front bottom zone also incorporates numerous electronic systems and pieces of equipment, ventilation systems, and also numerous electrical connection elements (cables, connectors, . . . ) and ventilation systems elements (pipes, couplings, ducts,

More particularly, these pieces of equipment, systems and connection elements are housed:
in the top space between the floor of the top deck and the roof of the landing gear bay;
in the lateral spaces situated between the lateral flanks of the landing gear bay, the side walls of the fuselage, and the floor;
in the front space between the front face of the landing gear bay and the radome zone; and also
in the rear space between the rear face of the landing gear bay and the rear of the bottom zone.

The top space is of relatively small volume that is difficult to access, thus making it difficult to fit out, in particular for passing electrical connection elements and ventilation systems elements therethrough.

Furthermore, the two lateral spaces are not suitable for incorporating all types of equipment because of their relatively small volume and more particularly because of the presence of connection rods arranged obliquely between the landing gear bay and the reinforcing frames of the fuselage. Working in these lateral spaces is thus uncomfortable.

Furthermore, integrating systems and equipment in the front bottom zone requires a large number of electrical connection elements and of ventilation systems elements between the various components in this zone, and also with the remainder of the aircraft.

In this bottom zone, the connection elements between the systems and the pieces of equipment are difficult to put into place because of the difficult access. This must necessarily be done on board the aircraft since it is not possible to implement a preassembly outside the aircraft.

Furthermore, very many connection elements between the electrical and ventilation systems and pieces of equipment also need to be put into place between the front bottom zone and the remainder of the aircraft, in particular between the front bottom zone and the cockpit. This task is made difficult by the presence of the cockpit floor.

### SUMMARY OF THE INVENTION

The present invention seeks to improve the prior art by proposing an aircraft front portion comprising a fuselage having fuselage frames, a cockpit, a cockpit floor acting as a plane for the crew to walk on, and a landing gear storage bay, the front portion being characterized in that the landing gear storage bay is arranged under the cockpit floor and is mechanically connected to at least some of the fuselage frames in order to provide the function of taking up the mechanical forces exerted on said fuselage frames under the effect of pressurization in the absence of the cockpit floor having a structural portion.

Thus, the cockpit floor performs the function of a plane for walking on but no longer participates, as in the prior art, in performing the function of taking up forces from the fuselage frames. In the prior art, this function is performed by the structural portion of the floor that includes cross-members each extending transversely between two opposite points of a given fuselage frame. That function is now incorporated directly in the landing gear storage bay, which is itself directly connected to the fuselage frames. In the absence of a structural floor portion, this makes it possible to maintain the general shape of the fuselage under the effect of pressurization. Furthermore, this direct mechanical connection between the landing gear bay and the fuselage frames provides the landing gear bay with greater ability to withstand deformation.

Omitting the structural portion of the floor (the cross-members) makes it possible to simplify the structure of the floor, to lower the remaining portion of the floor which constitutes the plane for walking on, and thus to release space inside the cockpit, thereby making the cockpit more ergonomic. The space available inside the cockpit is thus increased vertically, in particular in the central zone of the cockpit and also longitudinally (towards the nose of the aircraft). This vertical increase in space makes it possible both to move the seats of the pilot and of the copilot forwards closer to the windshield and also to lower them (so that they are moved parallel to the slope of the windshield).

Installing connection elements of electrical and ventilation systems and pieces of equipment between those in the zone containing the landing gear bay (bottom zone of the aircraft front portion) and those in the cockpit is also made easier because of the omission of the structural portion of the cockpit floor.

Furthermore, the bottom zone of the aircraft front portion situated under the cockpit is more ergonomic for working in than it is in the prior art.

It should be observed that implementing the invention does not require any modification to the shape of the aircraft fuselage.

According to other possible characteristics taken in isolation or in combination with one another:
the landing gear storage bay is mechanically connected to all of the fuselage frames that surround said landing gear storage bay;
the aircraft front portion includes, on either side of the landing gear storage bay, mechanical connection elements, each of which is fastened firstly to said bay and secondly to a fuselage frame; these mechanical connection elements act as reinforcing cross-members that serve firstly in co-operation with the landing gear bay to maintain the shape of the fuselage section when it is pressurized, and secondly also serve to perform an anti-warping function that was previously provided by the diagonal rods; connection elements may be arranged between each fuselage frame and the bay; by way of example, the connection elements may be rods;
the mechanical connection elements are arranged parallel to the cockpit floor; such an arrangement enables the space defined by the fuselage frames, the landing gear bay, and the mechanical connection elements to be made more accessible and thus easier to fit out; such mechanical connection elements are thus arranged horizontally when the aircraft is parallel to the ground;
the mechanical connection elements are arranged parallel to a “top” (roof) wall of the landing gear storage bay;
the mechanical connection elements are fastened to a “top” portion of the landing gear storage bay in such as a manner as to provide force continuity between said bay top portion, the mechanical connection elements, and the fuselage frames; the assembly constituted by the mechanical connection elements and the top portion of the bay acts like the complete cross-members of the prior art that extend between two opposite points of a given fuselage frame;
the landing gear storage bay includes a plurality of reinforcing crossbeams mounted around it, each mechanical connection element being fastened firstly to a reinforcing crossbeam of said bay, and secondly to a fuselage frame; as a variant, if there are no reinforcing crossbeams around the bay, the connection elements are fastened to mechanically reinforced zones of the top portion (roof) of the bay in order to provide mechanical force continuity between the frames, the connection elements, and the bay roof;
each reinforcing crossbeam is arranged in the same cross-section as a fuselage frame, each reinforcing crossbeam having a rectilinear portion arranged transversely against a top wall of the landing gear storage bay, two mechanical connection elements being arranged on either side of the rectilinear portion, in alignment therewith and fastened thereto;
the landing gear storage bay has a top wall of a shape that is designed to match as closely as possible the shape of landing gear in the folded position in said storage bay;
the top wall of the landing gear storage bay is generally staircase-shaped, rising towards the front end of the front portion of the aircraft; such a general shape serves to fit more closely to the shape of the landing gear in the folded position in said storage bay and presents plane portions that are horizontal when the aircraft is in a horizontal position, e.g. on the ground, which portions are as large as possible, thus serving to release the volume that can easily be used for incorporating equipment or for enabling the walking level to be lowered as far as possible;
the top wall of the landing gear storage bay comprises a first plate, a second plate situated at a height lower than the height of the first plate, and an inclined intermediate portion interconnecting the two plates; the first and second plates constitute horizontal plane portions that are as large as possible; the intermediate portion (the offset between the two plates) is inclined and not upright like a genuine stair riser, firstly so as to enable the landing gear to be housed as close as possible to the top wall, and secondly so as to leave sufficient material in the top wall at the location where the top bearing of the landing gear strut is fastened to the bay (in order to make it possible to take up the structural forces that act via the bearing);
the aircraft front portion includes a non-pressurized zone that is situated at the front end of said aircraft front portion and that is separated from the pressurized zone of said aircraft front portion by a separation partition, the landing gear storage bay being arranged adjacent to said separation partition; by arranging the landing gear bay in the zone of the aircraft that is situated as far forward as possible (close to the front end containing the radar equipment zone and, more particularly, against the partition separating the radar equipment zone from the aircraft zone situated under the cockpit), front space for fitting out and/or equipping in front of the bay is eliminated by favoring the opposite rear space that is easier to access; the front bottom zone where the bay is situated is thus more ergonomic;
the aircraft front portion includes a cockpit access passage having a passage floor, the cockpit floor being arranged at a height lower than the height of the passage floor; the cockpit floor can thus be lowered insofar as its structural portion is omitted, as explained above; and
the aircraft front portion includes a stair arranged in the cockpit to connect the cockpit floor with the passage floor; this stair may be installed in the cockpit given the extra space obtained vertically as a result of lowering the cockpit floor.

In another aspect, the invention provides an aircraft landing gear storage bay that is characterized in that it comprises:
a “top” portion;
mechanical connection elements (e.g., rods) that are fastened to said top portion and that serve to provide mechanical connection between the landing gear storage bay and fuselage frames of the aircraft so as to take up all of the mechanical forces exerted on said fuselage frames under the effect of pressurization. Such a bay thus makes it possible to omit the structural portion of the cockpit floor that used to perform this function of taking up mechanical force via the reinforcing cross-members, thus making it possible to restrict the functions of the floor merely to providing a plane for the crew to walk on.

According to a possible characteristic, the mechanical connection elements extend the top portion of the bay.

More particularly, the bay comprises:
a top wall (bay roof) comprising a first plate, a second plate situated at a lower height than the height of the first plate, and an inclined intermediate portion interconnecting the two plates;
two opposite lateral flanks that extend downwards from the top wall;
a plurality of parallel reinforcing crossbeams mounted around the landing gear storage bay against the top wall and against its opposite lateral flanks; and
two lateral mechanical connection elements fastened to at least some of the reinforcing crossbeams on either side thereof, said two elements being arranged in the same cross-section as the crossbeam in question.

According to a possible characteristic, each reinforcing crossbeam has a rectilinear portion arranged transversely against the top wall of the landing gear storage bay, two lateral mechanical connection elements being arranged on either side of the rectilinear portion, in alignment therewith, and fastened thereto.

The invention also provides an aircraft including an aircraft front portion as described above or an aircraft landing gear storage bay as described briefly above.

### BRIEF DESCRIPTION OF THE DRAWINGS

Other characteristics and advantages appear from the following description given purely by way of non-limiting example and made with reference to the accompanying drawings, in which:

FIG. 1 is a general diagrammatic view in longitudinal section of the front portion of an aircraft in an embodiment of the invention;

FIG. 2 is a diagrammatic view on a larger scale and in longitudinal section of a landing gear bay of the invention and of landing gear shown in its retracted and deployed positions;

FIG. 3 is a diagrammatic longitudinal section view of the front portion of an aircraft including a new configuration for the floor of the cockpit in an embodiment of the invention;

FIG. 4 is a diagrammatic perspective view from the rear of a landing gear bay of the invention;

FIG. 5 is a diagrammatic perspective view from the rear of the FIG. 4 landing gear bay installed in the aircraft front portion; and

FIGS. 6 and 7 are comparative views in cross-section level with the cockpit shown the front portion of an aircraft respectively of the invention and of the prior art.

### DETAILED DESCRIPTION OF THE PREFERRED EMBODIMENTS

By way of example, and as shown in fragmentary longitudinal section in

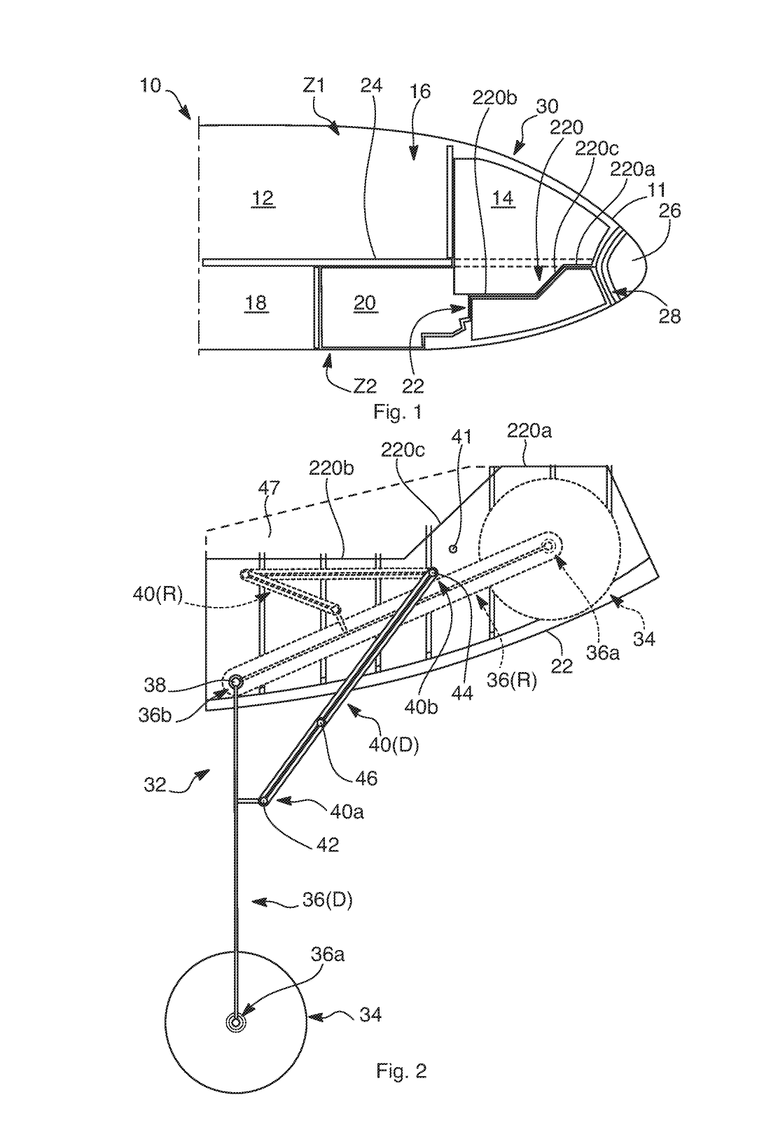

FIG. 1, an aircraft given overall reference 10 includes two levels or zones, namely a top zone Z1 and a bottom zone Z2. The top zone Z1 has a cabin zone 12 dedicated to passengers and, towards the front of the aircraft, a front zone 14 dedicated to the cockpit. The front zone or cockpit 14 is separated from the cabin zone 12 by a passage 16 giving access to the cockpit. The bottom zone Z2 has a rear cargo zone 18 serving in particular to receive containers, and a front bottom zone 20 that is dedicated to integrating electronic equipment and systems (avionics bays, . . . ), and ventilation equipment and systems, and that also receives the nose landing gear housed in its landing gear bay 22. The cabin zone 12 and the access passage 16 are separated from the bottom zone Z2 by a floor 24.

At its front end, in front of the cockpit 14 and the front bottom zone 20, the aircraft has a radar equipment zone or “radome” zone 26 (which zone is not pressurized) that is separated from the remainder of the aircraft by a partition 28. This partition is a shield for providing protection against bird strikes. The landing gear bay 22 is arranged against this partition 28 and beneath the cockpit 14.

The assembly constituted by the cockpit 14, the radome zone 26, the passage 16 giving access to the cockpit, and the bottom zone 20 with the landing gear bay 22, and also the various elements that are to be found in these zones constitute the front portion 30 of the aircraft. Nevertheless, depending on the particular aircraft configuration to which the invention might be applied, it is possible for the definition of its front portion to vary.

As shown in FIG. 1, the landing gear storage bay 22 has a top wall 220, or landing gear bay roof, that is generally in the shape of a staircase step going up towards the front end of the front portion of the aircraft (zone 26) in order to fit as closely as possible around the shape of the nose landing gear 32 when it is in its folded position in said bay (FIG. 2). It should be observed that the riser is inclined and not upright as it would be for a conventional staircase step, for reasons of withstanding the forces to which the bay is subjected by the landing gear.

As shown in FIG. 2, the landing gear 32 has two wheels, only one of which 34 is shown in the figure, which wheels are arranged on either side of the end of a leg 36. The leg 36 is hinged at its opposite end 36b about a transverse axis 38. This hinge enables it to pivot between firstly a deployed position given reference 36(D) in which the landing gear extends outside the bay, and secondly a retracted position, given reference 36(R) in which the landing gear is folded or stored inside the bay.

The landing gear 32 also has a thrust strut 40 having one end 40a hinged about an axis 42 secured to the leg 36. The strut 40 also has an opposite end 40b that is hinged about an axis 44 secured to the lateral walls or flanks of the landing gear bay 22. An intermediate hinge axis 46 is provided between the two opposite ends 40a and 40b so as to enable the strut to be housed in a relatively small space when in the folded position. The role of the strut is to block the landing gear in position when it is extended from the bay, and thus to prevent it from turning. The landing gear is pivoted by means of one or more retraction jacks that are not shown in the figure.

More particularly, the roof of the landing gear bay 220 has a first plane plate 220a, a second plane plate 220b situated at a height lower than that of the first plate, and an inclined plane intermediate portion 220c interconnecting the two plane plates.

The landing gear bay is used (together with connection elements connected to fuselage frames that are described below) to perform the function of cross-members of the structural portion of the cockpit floor (prior art) each cross-member extending between two opposite points of a single fuselage frame. The cockpit floor in the prior art is drawn with dashed lines in FIG. 1, and it extends the floor 24.

Omitting those cross-members and thus the structural portion of the floor makes it possible to lower the remaining portion of the floor which acts as a plane for the crew to walk on.

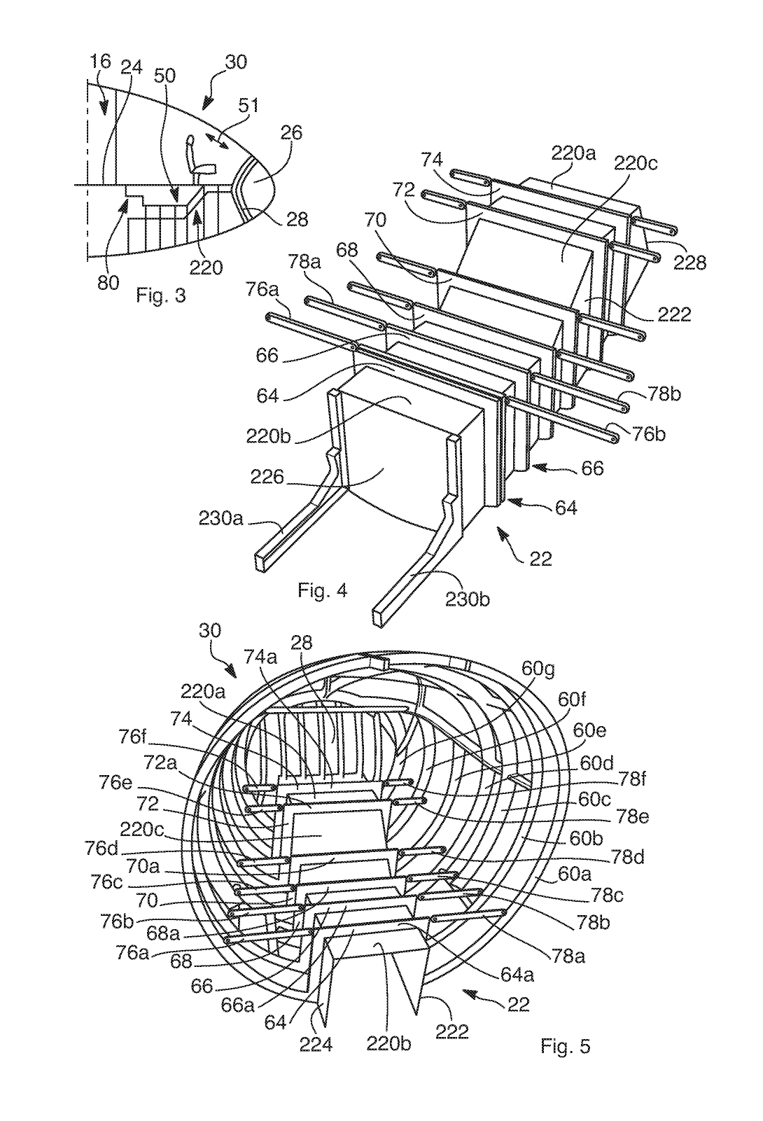

Above the bay roof 220, the cockpit floor has the portion of the floor on which the cockpit crew walks and it is referred to as the plane 50 for walking on (FIG. 3). It comprises one or more panels, e.g. made of composite material, that also perform thermal and acoustic insulation functions. This or these panels may for example rest on the bay roof and they may be fastened thereto by means of conventional supports, e.g. in register with crossbeams reinforcing the bay as described in detail below with reference to FIGS. 4 and 5.

As shown in FIG. 3, the profile of the plane 50 for walking on follows substantially the staircase profile of the roof 220.

FIG. 4 shows the bay 22 in a perspective view from behind and FIG. 5, likewise in perspective view from behind, shows the same bay installed in the aircraft front portion 30, of which only the reinforcing framework is shown.

In addition to the above-described roof 220, the bay 22 comprises:
two lateral walls or flanks 222, 224 that extend vertically down from the roof 220 to the bottom portion of the fuselage;
a rear wall 226 that extends vertically down from the rear end of the bottom plate 220b of the roof 220 to the bottom portion of the fuselage; and
an inclined front wall 228 defining the front face of the bay 22 that is to be arranged against the partition 28 of the radome zone 26.

The front and rear walls, also referred to as pressurized strong frames, are designed to accommodate the main mechanical forces generated by the landing gear.

Two force attenuation beams 230a, 230b deliver forces rearwards from the bay, into the fuselage, which forces are generated mainly in the bottom portion of the landing gear bay at the hinge bearings of the landing gear (on the pivot axis of the landing gear), and in particular are forces that act in the longitudinal direction of the aircraft.

The bay 22 with plane external faces is open in its bottom face opposite from the roof (as shown in FIG. 5 where the rear wall 226 has been omitted) in order to allow the landing gear to be extended from the bay and to be returned therein.

As shown in FIG. 5, the aircraft front portion 30 has a plurality of transverse frames 60a, 60b, . . . , 60g for reinforcing the fuselage (referred to below as fuselage frames) arranged in mutually parallel manner against the fuselage of the aircraft front portion and spaced apart relative to one another in the longitudinal direction of the fuselage. Each of these fuselage frames extends in a single cross-section of the aircraft and is approximately circular in shape. The fuselage frames that meet the bottom portion of the landing gear bay, via its lateral flanks 222, 224, are interrupted in their bottom portions.

A plurality of reinforcing crossbeams 64, 66, . . . , 74 in the form of mutually parallel arches are mounted around the landing gear storage bay against the roof 220 and its two opposite lateral flanks 222 and 224. The crossbeams reinforce the lateral flanks 222, 224 and the roof of the bay, and in particular they guarantee that the bay retains its shape against the effects of pressurization. Each crossbeam is arranged in the same cross-section as a corresponding fuselage frame, and each crossbeam is fastened to a corresponding frame in its bottom portion where they meet, as explained above.

A plurality of connection elements or cross-members (e.g. in the form of rods) are fastened between the reinforcing crossbeams 64, 66, . . . , 74 and the respective fuselage frames 60a, 60b, . . . , 60g that occupy the same cross-sections. These connection elements are positioned on either side of the landing gear storage bay 22 and they provide a horizontal mechanical connection level with each reinforcing crossbeam.

More particularly, each crossbeam has a horizontal rectilinear portion 64a, 66a, . . . , 74a arranged transversely against the roof of the bay for storing the landing gear. Two connection elements 76a, 78a, 76b, 78b, . . . , 76f, 78f are arranged respectively on either side of each rectilinear portion 64a, 66a, . . . of each of the crossbeams, in alignment with said rectilinear portion. Each connection element is fastened at one end to said rectilinear portion, and at its opposite end to the corresponding fuselage frame 60a, 60b, . . . , 60f The central horizontal portion of each crossbeam provides physical continuity between the two connection elements on either side thereof These three components together act as a complete cross-member serving, in each fuselage frame, to maintain the general shape of the fuselage against pressure by opposing the deformation of said fuselage under the effects of pressure. Furthermore, these three components together also serve to avoid the landing gear bay warping and thus they participate in maintaining the shape of the landing gear bay.

As shown in FIG. 3, a stair 80 is provided in the cockpit 14 to connect the cockpit floor and more particularly its plane 50 for walking on to the floor 24 of the passage 16 that gives access to the cockpit and that is at a greater height. Crew members can thus easily enter and leave the cockpit.

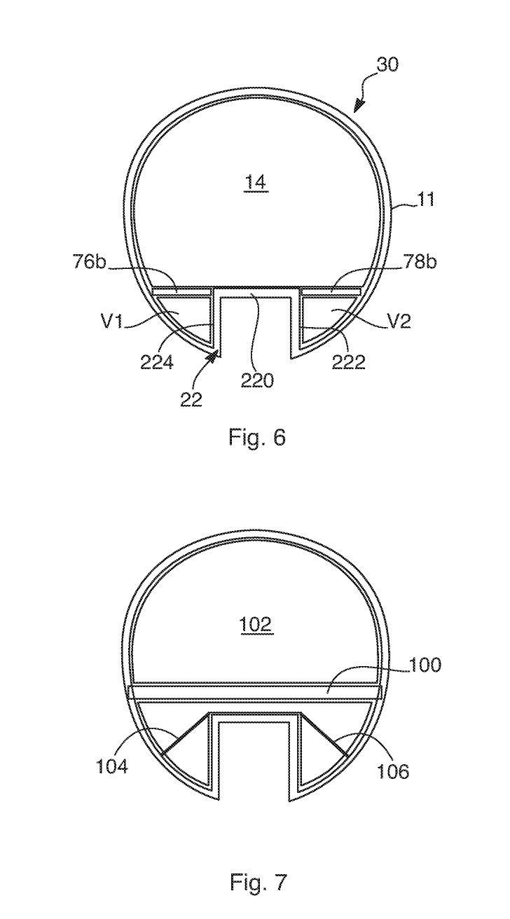

FIGS. 6 and 7 are comparative cross-section views level with the cockpit showing the front portion of an aircraft respectively of the invention and of the prior art.

As shown in cross-section in FIG. 6 (section plane including a fuselage frame, a reinforcing crossbeam, and two transverse connection elements or rods 76b, 78b), two spaces V1 and V2 of relatively small volume are provided laterally on either side of the bay 22 for storing the landing gear. Each of these spaces is defined by the lateral flanks 222, 224 of the landing gear storage bay, the walls of the bottom portion of the aircraft fuselage 11 (more particularly the two bottom portions of each fuselage frame that are joined to the lateral flanks of the bay) and the plane (a horizontal plane when the aircraft is on the ground) defined by the transverse connection elements or rods situated on either side of the bay roof 222. Each of these spaces V1, V2 is of a substantially triangular shape in cross-section (plane of FIG. 6) and extends longitudinally along the lateral flanks of the bay, i.e. perpendicularly to the plane of FIG. 6.

These spaces of smaller volume than in the prior art can voluntarily be left empty, thus making it possible to omit external access hatches (not shown) that are normally used for accessing these spaces from the outside in order to install and maintain equipment. Furthermore, these spaces do not have any diagonal rods connecting the landing gear bay to the fuselage frames, like the prior art rods 104, 107 (FIG. 7). The anti-warping function for the bay is provided by the horizontal transverse connection elements that extend the top portion of the bay and that thus prevent the triangular sections of the spaces V1 and V2 from deforming (non-deformable triangle effect). The absence of such rods makes access to the spaces V1 and V2 easier, should it be decided to install equipment therein.

The new landing gear bay 22 of the invention enables the height to the cockpit floor to be lowered compared with the height of the prior art floor 100 (FIG. 7), thereby providing extra volume vertically in the cockpit 14 compared with the prior art cockpit 102. This makes the cockpit more ergonomic. Furthermore, access to the cockpit with its lower floor from the access passage 16 of FIGS. 1 and 3 is thus facilitated.

As shown in FIG. 3 by arrow 51, the “cockpit” function (the seats of the pilot and copilot and the instrument panel) can be moved forwards as shown by the arrow which extends parallel to the slope of the windshield.

Furthermore, as shown both in FIG. 1 and in FIG. 6, the specific arrangement of the novel landing gear bay 22 provides a single volume in the front bottom zone (ignoring the lateral spaces V1 and V2) that is thus easier to fit out than in the prior art.

The gain in volume for the cockpit and the front bottom zone is also made possible by the smaller volume of the landing gear bay of the invention. This reduction in the volume or overall size of the landing gear bay comes from optimizing the linkage for storing the strut 40, i.e. optimizing the positions of its attachment points and the length ratios of its arms.

In FIG. 2, reference 41 shows the position that would be occupied by the point of attachment to the axis 44 of the strut 40 in a larger prior art bay of outline represented by dashed lines. Furthermore, reference 47 shows the position that would be occupied by the hinge point 36 of the strut 40 in the above-mentioned prior art bay.

Furthermore, it is much easier than in the prior art to install electrical connection elements, air ducts, and various air circuit elements between the bottom zone of the front portion of the aircraft and the cockpit as a result of there no longer being the structural portion of the cockpit floor.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An aircraft front portion comprising a fuselage comprising:
fuselage frames,
a cockpit,
a cockpit floor acting as a plane for the crew to walk on, and
a landing gear storage bay,
the landing gear storage bay being arranged under the cockpit floor and being mechanically connected to at least some of the fuselage frames in order to provide the function of taking up the mechanical forces exerted on said fuselage frames under the effect of pressurization of the cockpit in the absence of the cockpit floor having a structural portion.

2. The aircraft front portion according to claim 1, wherein the landing gear storage bay is mechanically connected to all of the fuselage frames that surround said landing gear storage bay.

3. The aircraft front portion according to claim 1, further including, on either side of the landing gear storage bay, mechanical connection elements, each of which is fastened firstly to said bay and secondly to one of the fuselage frames.

4. The aircraft front portion according to claim 3, wherein the mechanical connection elements are arranged parallel to the cockpit floor.

5. The aircraft front portion according to claim 3, wherein the mechanical connection elements are arranged parallel to a top wall of the landing gear storage bay.

6. The aircraft front portion according to claim 3, wherein the mechanical connection elements are fastened to a top portion of the landing gear storage bay in such as a manner as to provide continuity between said bay top portion, the mechanical connection elements, and the fuselage frames.

7. The aircraft front portion according to claim 1, wherein the landing gear storage bay includes a plurality of reinforcing crossbeams mounted around it, each mechanical connection element being fastened firstly to a reinforcing crossbeam of said bay, and secondly to a fuselage frame.

8. An aircraft front portion according to claim 7, wherein each reinforcing crossbeam is arranged in the same cross-section as a fuselage frame, each reinforcing crossbeam having a rectilinear portion arranged transversely against a top wall of the landing gear storage bay, two mechanical connection elements being arranged on either side of the rectilinear portion, in alignment therewith and fastened thereto.

9. The aircraft front portion according to claim 1, wherein the landing gear storage bay has a top wall of a shape that is designed to match as closely as possible a shape of landing gear in a folded position in said storage bay.

10. An aircraft front portion according to claim 9, wherein the top wall is generally staircase-shaped, rising towards the front end of the front portion of the aircraft.

11. An aircraft front portion according to claim 10, wherein the top wall of the landing gear storage bay comprises a first plate, a second plate situated at a height lower than the height of the first plate, and an inclined intermediate portion interconnecting the two plates.

12. An aircraft front portion according to claim 1, further comprising a non-pressurized zone that is situated at a front end of said aircraft front portion and that is separated from the pressurized zone of said aircraft front portion by a separation partition, the landing gear storage bay being arranged adjacent to said separation partition.

13. An aircraft front portion according to claim 1, further comprising a cockpit access passage having a passage floor, the cockpit floor being arranged at a height lower than the height of the passage floor.

14. An aircraft front portion according to claim 13, further comprising a stair arranged in the cockpit to connect the cockpit floor with the passage floor.

15. An aircraft, comprising an aircraft front portion according to claim 1.
